(19) United States
(12) Patent Application Publication
(10) Pub. No.: US 2022/0042306 A1
(43) Pub. Date: Feb. 10, 2022

(54) Methods, Systems, and Kits for Building Interlocking Seawalls

(71) Applicant: William Donnelly, Barrington, NH (US)

(72) Inventor: William Donnelly, Barrington, NH (US)

(21) Appl. No.: 17/505,876

(22) Filed: Oct. 20, 2021

Related U.S. Application Data
(63) Continuation of application No. 16/155,990, filed on Oct. 10, 2018, now abandoned.
(60) Provisional application No. 62/577,633, filed on Oct. 26, 2017.
(60) Provisional application No. 62/577,917, filed on Oct. 27, 2017.

(51) Int. Cl. E04C 1/39; A63H 33/10; E04B 2/02; E02B 3/14; E02D 29/02; E02D 27/01; E02B 3/10; E04B 2/18

(52) U.S. Cl. CPC E04C 1/397; A63H 33/107; E04B 2/02; E02B 3/14; E02D 29/02; E02D 27/01; E04B 2/26; E02B 3/10; E04B 2/18; E04B 2002/028; E04B 2002/0243; E04B 2002/0289; E04B 2002/0245; E04C 1/395

(57) ABSTRACT

This disclosure provides methods, systems, and kits for building seawalls using mechanically interlocking blocks. The interlocking blocks have interiors that can be filled with sand, gravel, or cementitious material after formation of a wall. The interlocking blocks that can be connected on any side to form a structure, wall, foundation, floor, building, flotation device, gardening structure, or toy. The interlocking blocks typically comprise center openings and connecting openings on each side and can be connected with hardware through the connecting openings. The center openings allow for materials such as pipes, wires, conduit, and rebar to pass through interlocked blocks. Connected blocks can also be filled with fortifying material to strengthen the structure. Sides of connected blocks can be covered with faceplates to direct flow of fortifying material and aid in the creation of desired configurations. Also provided are connectors for connecting sides of the interlocking blocks.

### PRIORITY

This application is a continuation of U.S. application Ser. No. 16/155,990, filed Oct. 10, 2018, which claims priority to U.S. Provisional Application No. 62/577,917, filed Oct. 27, 2017 and titled “Interlocking Rectangular Prism Blocks Connecting Building Structures” and to U.S. Provisional Application No. 62/577,633, filed Oct. 26, 2017 and titled “Interlocking Trapezoidal Prism Blocks Connecting Building Structures,” all of which applications are incorporated herein by reference in their entireties.

### FIELD

This disclosure relates to interlocking blocks. More specifically, this disclosure relates to interlocking blocks for use in construction, flotation, and a variety of other uses.

### BACKGROUND

Presently, building blocks do not have the capability to be locked together from the top, bottom, and all sides, along with being able to pass rebar, pipes, conduit and other materials through the bodies of all the blocks as they are interlocked together. Further, existing interlocking blocks are unable to connect to either side of another interlocking block.

Current wall systems lack sufficient strength and height to prevent rising sea waters from breaching the walls. With waters continuing to rise, governments and municipalities around the world need to reinforce existing walls, build new walls, and engineer additional solutions to prevent incoming water from destroying waterfront structures and localities.

A major drawback of existing wall systems is their inability to be joined together on all sides by additional interlocking blocks. A second major drawback of current interlocking blocks and wall systems is the inability to pass materials such as rebar, pipes, wire, conduit, etc. through the interlocked blocks in different directions. A third major drawback of existing interlocking blocks and wall systems is the inability to fill interlocked blocks with strengthening materials to form one continuous and solid structure.

A need exists for improved interlocking blocks for retaining walls, sea walls, foundations, buildings, and other applications.

### SUMMARY

In one aspect, this disclosure provides an interlocking block, comprising at least three parallelogram sides, wherein each side comprises a side center opening around the center of the side, four side corners, at least one side interlocking opening proximate to each side corner; and two ends. In some embodiments, the interlocking block comprises a plurality of side interlocking openings proximate to each side corner. In further embodiments, the interlocking block comprises four side edges and one or more side edge openings proximate to one or more of the side edges. In still further embodiments, the interlocking block comprises at least one faceplate. In yet further embodiments, the at least one faceplate is connected to one side center opening of one side. In other embodiments, each end of the interlocking block comprises an end center opening around the center of the end, at least three end corners, and at least one end interlocking opening proximate to at least one end corner.

In another aspect, this disclosure provides a method of connecting a first interlocking block and a second interlocking block, comprising providing a first interlocking block comprising a first side comprising a first side center opening around the center of the first side, four first side corners, four first side interlocking openings, each first side interlocking opening being proximate to a first side corner. Then, the method comprises providing a second interlocking block comprising: a second side comprising a second side center opening around the center of the second side, four second side corners, four second side interlocking openings, each second side interlocking opening being proximate to a second side corner. The method also comprises aligning the four first side interlocking openings with the four second side openings and inserting hardware through at least one aligned first side interlocking opening and a second side interlocking opening, thereby connecting the first interlocking block and the second interlocking block.

In some embodiments, the hardware is selected from the group consisting of a bolt, a screw, a nut, threaded rod, a plastic insert, and a washer. In other embodiments, the first interlocking block comprises a third side and the method further comprises attaching a faceplate to the third side.

In further embodiments, the first side comprises first four edges and one or more first edge openings located proximate to one or more of the first four edges, and wherein the second side comprises second four edges and one or more second edge openings located proximate to one or more of the second four edges, and the method further comprises inserting hardware through one or more first edge openings and one or more second edge openings.

Some embodiments of the method further comprise inserting a sleeve through the first side center opening and the second side center opening, wherein the sleeve comprises threads on an inside surface of the sleeve, screwing a plug into the sleeve, wherein the plug comprises an outside surface comprising outside threads, and wherein the plug is hollow and comprises an inside surface comprising inside threads, and screwing a receiving connector into the inside threads of the plug, wherein the receiving connector comprises a receiving outside surface comprising receiving outside threads. In certain embodiments the receiving connector is hollow through its length.

Yet another aspect of this disclosure is directed to an interlocking block structure, comprising a plurality of interlocking blocks, wherein each interlocking block comprises five or more sides, and wherein each side comprises a center opening and a plurality of connecting openings, wherein the plurality of interlocking blocks are connected by hardware through the connecting openings, and wherein a plurality of the center openings are aligned.

In some embodiments, the interlocking block structure further comprises one or more pipes within the center openings of two or more interlocking blocks. In other embodiments, the interlocking block structure further comprises one or more wires within the center openings of two or more interlocking blocks. In further embodiments, the interlocking block structure further comprises conduit within the center openings of two or more interlocking blocks.

In some embodiments, the interlocking block structure is filled with a material or a combination of materials. In certain embodiments, the material is selected from the group consisting of sand, cement, water, gravel, rock, or a combination thereof. In further embodiments, the interlocking block structure is a wall, floor, foundation, garden, or flotation device.

Another aspect of this disclosure is directed to a connecting system comprising a plug comprising an outside surface comprising outside threads, wherein the plug is hollow and comprises an inside surface comprising inside threads, a hollow sleeve comprising an inside surface comprising sleeve threads, and a receiving connector comprising an outside surface comprising receiving threads. In some embodiments, the receiving connector is hollow.

Another aspect of this disclosure is directed to kits comprising a number of blocks for a specific use and hardware for connecting the blocks. In some embodiments, the kits comprise a number of blocks and hardware for connecting the blocks for use as a flotation device. In other embodiments, the kits comprise a number of blocks and hardware for connecting the blocks for use in gardening. In yet other embodiments, the kits comprise a number of blocks and hardware connecting the blocks for use as a toy. In some embodiments, the kits also comprise faceplates and hardware for connecting the faceplates. In further embodiments, the kits comprise instructions for connecting the blocks and/or for recommended configurations of the blocks.

### BRIEF DESCRIPTION OF THE FIGURES

FIG. 1 depicts a three-dimensional view of an embodiment of an interlocking block.

FIG. 2 depicts a three dimensional view of an embodiment of an interlocking block.

FIG. 3A depicts a side view of hardware aligned with connecting openings of aligned interlocking blocks. FIG. 3B shows a cutout view of two aligned interlocking blocks without hardware.

FIG. 4 depicts two interlocking blocks aligned prior to connecting with a gasket interposed between the interlocking blocks.

FIG. 5 depicts six interlocking blocks connected together in an exemplary configuration.

FIG. 6 depicts an interlocking block with a faceplate covering one side of the interlocking block.

FIG. 7 depicts shows a plurality of interlocking blocks connected together in an exemplary configuration.

FIG. 8 depicts shows a plurality of interlocking blocks connected together in an exemplary configuration.

FIG. 9 depicts a side view of a side of an interlocking block.

FIG. 10 depicts an exemplary structure comprised of interlocking blocks.

FIG. 11 depicts an exemplary configuration of interlocked blocks with faceplates attached to one side.

FIG. 12 depicts an exemplary configuration of interlocked blocks with faceplates attached to one side.

FIG. 13 shows an exemplary illustration of a plug, sleeve, and receiving connector.

FIG. 14 shows an exemplary assembled plug, sleeve, and receiving connector.

FIG. 15 shows an embodiment of an interlocking block.

### DETAILED DESCRIPTION

This disclosure provides interlocking blocks that can be made of a variety of materials and have a variety of applications. More specifically, this disclosure provides interlocking prisms that can be connected together mechanically on each side of the block.

As used herein, the term “prism” means a geometric figure comprising two ends that are the same or similar and three or more sides that are parallelograms. The terms “block” and “prism” are used interchangeably herein, unless contextually or specifically stated otherwise. As used herein, the term “side” and refers to a side and/or end of an interlocking block, unless contextually or specifically stated otherwise.

As used herein, the term “and/or” includes any and all combinations of one or more of the associated items. As used herein, the terms “a”, “an”, and “the” mean one or more, unless contextually or specifically indicated otherwise. As used herein, the term “about” means +/−10% of a stated value.

As the climate on the Earth continues to change and sea levels continue to rise, stronger and higher retaining walls and seawalls are needed to protect coastal communities. The interlocking blocks of this disclosure can be used to build stronger and taller retaining walls and seawalls that are filled with fortifying materials. Interlocked blocks can be filled with a solid, liquid, or gas. In some embodiments, the fortifying materials are insulation, sand, water, gravel, rocks, cementitious material, or a combination thereof. The design of the interlocking blocks also allows for objects to be passed through the blocks prior to filling them with material. For example, metal pipe, plastic pipe, wires, conduit, rebar, insulation, and other materials can be passed through the center openings of connected interlocking blocks prior to filling the structure with fortifying material. Walls created with the interlocking blocks of this disclosure are unlike any other walls in previous existence.

This disclosure provides mechanically interlocking prism blocks. Each interlocking block has a number of sides that are parallelograms and two identical ends. Unlike existing block systems, any side of the interlocking blocks of this disclosure can be connected to another block. In other words, the interlocking blocks of this disclosure can be connected on any end or parallelogram side. In some embodiments, the interlocking block has three parallelogram sides (referred to herein as “triangular”) and two ends. In other embodiments, the interlocking block has four parallelogram sides (referred to as “rectangular”) and two ends. In further embodiments, the interlocking block has five parallelogram sides (referred to as “pentagonal”) and two ends. In additional embodiments, the interlocking block has six parallelogram sides (referred to as “hexagonal”) and two ends. In still further embodiments, the interlocking block has more than six parallelogram sides and has two ends.

Each parallelogram side of an interlocking block comprises four corners and four edges. One or more sides and/or ends of an interlocking block comprise a center opening around its center. In some embodiments, the ends of an interlocking block comprise three or more corners and three or more edges. In some embodiments, one end or both ends of an interlocking block comprise a center opening around its center. In some embodiments, each center opening on a side aligns with the center opening on the opposite side. In some embodiments, one or more connecting openings are located proximate to each corner of each side. In some embodiments, one or more edge connecting openings are located proximate to the middle of one or more edges of the sides. The orientation and location of the connecting openings and edge openings varies. In some embodiments, the center opening, connecting opening, or edge opening is round. In other embodiments, the center opening, connecting opening, or edge opening is not round. As used herein, the term “connecting opening” can refer to either a connecting opening proximate to a corner on a side of an interlocking block or an edge opening proximate to an edge of a side of an interlocking block or both.

In some embodiments, all of the sides and ends of an interlocking block comprise a center opening. In other embodiments, all of the sides and ends of an interlocking block comprise a center opening and one or more connecting openings. In further embodiments, some sides and/or some ends have center openings, or connecting openings, or both. In some embodiments, one side or one end of the interlocking block has no center opening and no connecting openings. In other embodiments, two sides of the interlocking block have no center opening and no connecting openings. In further embodiments, one side and one end of the interlocking block have no center opening and no connecting openings. In still further embodiments, three sides of the interlocking block have no center opening and no connecting openings. In yet further embodiments, one side and two ends of the interlocking block have no center opening and no connecting openings. In additional embodiments, two sides and one end of the interlocking block have no center opening and no connecting openings. In some embodiments, four sides of the interlocking block have no center opening and no connecting openings. In some embodiments, two sides and two ends of the interlocking block have no center opening and no connecting openings. In some embodiments, three sides and one end of the interlocking block have no center opening and no connecting openings.

The center openings allow materials to pass through connected interlocking blocks in different directions, with the number of possible directions depending on the number of sides of that an interlocking block has. The center openings also allow interlocked blocks to be filled with material. For example, multiple interlocking blocks could be connected together and then filled with sand, cement, mud, rocks, gravel, water, insulation, gas, fluid, flotation materials, etc.

In some embodiments, the surfaces of the sides of an interlocking block are flat. In some embodiments, the surfaces of the sides of an interlocking block are smooth. In other embodiments, one or more surfaces of an interlocking block are rough. In further embodiments, one or more surfaces of an interlocking block comprises a non-slip coating, bumps, ridges, or grooves.

The interlocking blocks can be made of any suitable material, depending on the application of the blocks and the structure being constructed. Strong, consistent materials with a high load carrying ability and resistant to stresses can be used to make the interlocking blocks. In some embodiments, the interlocking blocks comprise steel. In certain embodiments, the interlocking blocks comprise electrogalvanized cold-rolled steel (SECC). In some embodiments, the interlocking blocks comprise cement. In certain embodiments, the interlocking blocks comprise hydraulic cement. In further embodiments, the interlocking blocks comprise cementitious materials. In some embodiments, the interlocking blocks comprise glass. In other embodiments, the interlocking blocks comprise plastic. In certain embodiments, the interlocking blocks comprise high-density polyethylene (HDPE or No. 2 plastic). In still further embodiments, the interlocking blocks comprise clear plastic. In additional embodiments, the interlocking blocks comprise silicone. In additional embodiments, the interlocking blocks comprise polyvinyl chloride. In further embodiments, the interlocking blocks comprise metal or alloy. In certain embodiments, the interlocking blocks comprise aluminum, copper, brass, or stainless steel. In additional embodiments, the interlocking blocks comprise wood and/or wood products. In some embodiments, the interlocking blocks comprise cloth. In further embodiments, the interlocking blocks comprise insulation. In some embodiments, the interlocking blocks comprise ceramic. In some embodiments, the interlocking blocks comprise a liquid material. In some embodiments, walls or floors or other structures comprising the interlocking blocks are made of a material and filled with another material. The walls or floors or structures comprising the interlocking blocks may be filled with air, floatable foam, insulation, or a cementitious material, or another material. In further embodiments, the interlocking blocks comprise a combination of materials described herein.

The sides of the interlocking blocks can be thick or thin depending on the application of the blocks and the structure being built. In some embodiments, the sides are thin. In other embodiments, the sides are thick. In further embodiments, the sides have a thickness ranging from about 1/16″ to about 12″. In some embodiment, the sides comprise an inner wall and an outer wall. In some embodiments, the sides comprise an inner wall and an outer wall and are hollow in between the inner wall and outer wall. In further embodiments, the sides are filled with a material between the inner wall and outer wall. In still other embodiments, the blocks are partially hollow, so that the only unfilled part of the blocks are the connecting openings, edge openings, and center openings.

The interlocking blocks can have a variety of sizes. In some embodiments, the blocks have edges that are uniform length. In other embodiments, the blocks have one length on the edges of the ends and a different length along the edges of the parallelogram that are not part of the end. In some embodiments, the blocks range in size from about 1 foot to about 20 feet. In other embodiments, the blocks range in size from about 1 foot to about 15 feet. In further embodiments, the blocks range in size from about 1 foot to about 10 feet. In still further embodiments, the blocks range in size from about 1 foot to about 8 feet. In other embodiments, the blocks range in size from about 1 foot to about 6 feet. In some embodiments, the blocks range in size from about 1 foot to about 4 feet. In some embodiments, the blocks range in size from about 1 foot to about 3 feet.

In some embodiments, the interlocking blocks range in size from about 1 inch to about 48 inches. In further embodiments, the interlocking blocks range in size from about 1 inch to about 36 inches. In still further embodiments, the interlocking blocks range in size from about 1 inch to about 24 inches. In particular embodiments, the interlocking blocks range in size from about 1 inch to about 12 inches.

In some embodiments, the edges of the blocks are about 1 foot long. In some embodiments, the edges of the block are between about 1 and about 2 feet long, inclusive. In further embodiments, the edges of the blocks are between about 2 and about 3 feet long, inclusive. In still further embodiments, the edges of the blocks are between about 3 and about 4 feet long, inclusive. In yet further embodiments, the edges of the blocks are between about 4 and about 5 feet long, inclusive. In certain embodiments, the edges of the blocks are between about 5 and about 6 feet long, inclusive.

In some embodiments, the edges of the end of a block range in size from about 1 inch to about 10 feet and the edges of the sides of the block range in size from about 1 inch to about 10 feet.

In some embodiments, a block further comprises a faceplate attached to a side of the block. A faceplate is designed to cover the center opening, connecting openings, edge openings, or some combination of center opening, connecting openings, and/or edge openings. When a faceplate is attached to a side, fortifying material does not pass through the openings on that side. When a structure is created from interlocked blocks, faceplates can be attached to a plurality of sides of the interlocked blocks prior to filling the interlocked blocks with a fortifying material. The faceplates allow for fortifying material to flow in a desired pattern.

In some embodiments, a plurality of faceplates are attached to a block or attached to a plurality of interlocked blocks. For example, when a wall is created from interlocked blocks, faceplates can be attached to one or more sides of the wall. Then, fortifying material can be poured into the wall comprised of interlocked blocks. The fortifying material will flow through the center openings of the interlocked blocks, but the faceplates will prevent the fortifying material from flowing in undesired directions.

Faceplates can be made of the same material as the interlocking block to which it attaches or a different material. In various embodiments, faceplates comprise wood, plastic, HDPE, PVC, rubber, glass, metal, metal alloy, aluminum, brass, copper, stainless steel, cloth, cementitious materials, ceramic, gasket material, silicone, or combinations thereof.

In some embodiments, the faceplates are adorned with designs or pictures to create an aesthetically pleasing appearance when attached to interlocked blocks. In certain embodiments, a plurality of faceplates makes up a large design. For example, a large design can be an image of nature, or a city, or a sequence, or an underwater scene, etc. In other embodiments, each faceplate has its own picture, painting, image, or design on it.

The disclosure also provides plugs for plugging a center opening or any opening of a side of an interlocking block. In some embodiments, the plug comprises a sleeve with threads on the inside and a screw to screw into the sleeve. When the sleeve is placed into an opening of an interlocking block, the plug can be screwed into the sleeve, thereby causing the sleeve to expand and plug the opening. In some embodiments, the plug and sleeve prevent fluid from passing through the opening. In some embodiments, the plug is removable.

In some embodiments, a receiving connector is inserted into the other side of the sleeve. The receiving connector has threads on the inside of it and the plug can screw into the receiving connector. As the plug threads into the receiving connector, the plug and receiving connector cause the sleeve to expand and plug the opening of a block or of two interlocked blocks. In some embodiments, the plug and receiving connector have ridges and grooves to aid in expanding the sleeve.

In some embodiments, the plug has threads on its outside that are threaded into the threads on the inside of the sleeve. In certain embodiments, the plug has threads on the inside and the receiving connector is threaded into the plug. In such embodiments, the plug threads into the sleeve and the receiving connector threads into the inside of the plug.

In some embodiments, the plug is used to connect the center openings of two or more interlocking blocks. In other embodiments, the plug is used to connect two or more connecting openings or edge openings of two or more interlocking blocks.

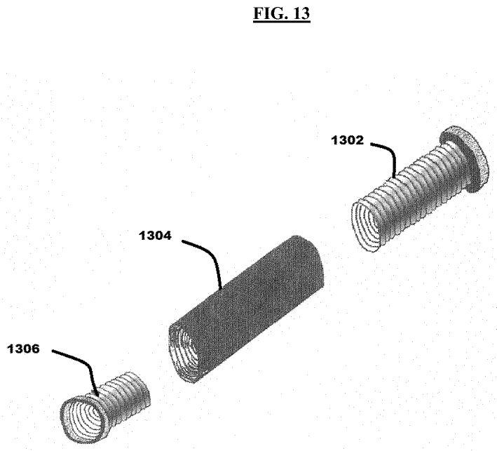

FIG. 13 shows an exemplary illustration of a plug, sleeve, and receiving connector.

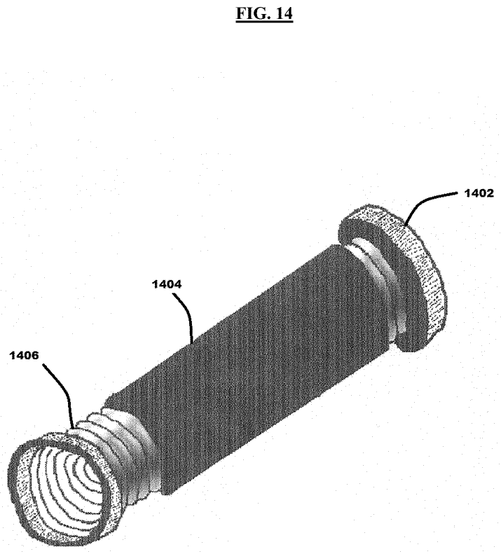

FIG. 14 shows an exemplary assembled plug, sleeve, and receiving connector. The plug, sleeve, and receiving connector are used to connect interlocking blocks. In some embodiments, the plug, sleeve, and receiving connector are used to connect the center openings of interlocking blocks.

The plug, sleeve, and receiving connector vary in size depending on the size of the opening of the interlocking block that they are designed to fit into.

The plug, sleeve, and receiving connector can each comprise rubber, plastic, foam, other suitable material, combinations thereof. In some embodiments, the plug is metal or wood. In some embodiments, the sleeve comprises a flange. In some embodiments, the receiving connector is metal or wood.

In some embodiments, the plug is hollow to allow objects to pass through it. In further embodiments, mechanical hardware is added through the hollow plug and receiving connector to add rigidity or structural integrity to interlocked blocks.

In some embodiments, the plug is designed to stretch from one center opening through an interlocking block and out a second center opening of an interlocking block. In such embodiments, the screw can be hollow to allow objects to pass through the screw, and, thus, through the interlocking block.

### Methods of Connecting Interlocking Blocks

This disclosure also provides methods of connecting interlocking blocks. The interlocking blocks of this disclosure are designed to be connected or interlocked. The blocks can be connected on any of the sides or ends.

This disclosure provides methods for connecting interlocking blocks with hardware. In an embodiment of the method, at least one first connecting opening of a first side of a first interlocking block is aligned with at least one second connecting opening of a second side of a second interlocking block. In some embodiments, the first side of the first interlocking block comprises a first center opening and the second side of the second interlocking block comprises a second center opening, and, during the aligning, the first center opening of the first interlocking block is aligned with the second center opening of the second interlocking block. At least one first connecting opening of the first side of the first interlocking block is connected to the least one second connecting opening of the second side of the second interlocking block with hardware.

Any suitable connecting hardware can be used. The disclosure provides numerous types of hardware that can be used. However, the embodiments provided in the disclosure are not meant to be exhaustive of all possible types of hardware that can be used. In some embodiments, the hardware comprises a screw. In some embodiments, the hardware comprises a nail. In some embodiments, the hardware comprises a bolt and a nut. In other embodiments, the hardware comprises threaded rod and a nut. In still other embodiments, the hardware comprises a washer. In further embodiments, the hardware comprises locking inserts which can be inserted into the at least one first connecting opening of the first side of the first interlocking block and into the least one second connecting opening of the second side of the second interlocking block, thereby connecting the two interlocking blocks. In still further embodiments, the hardware comprises mechanical fasteners. In additional embodiments, the hardware comprises grommets. In other embodiments, the hardware comprises inserts, latches, pins, retaining clips, rivets, rivet nuts, socket products, springs, toggle bolts, expandable foam inserts, expandable anchors, concrete anchors, plastic hardware, nuts, washers, and bolts. In some embodiments, the hardware is a combination of any of the hardware described herein, or other suitable hardware.

In some embodiments, the method comprises connecting a plurality of the first connecting openings of the first side of the first interlocking block to a plurality of the second connecting openings of the second side of the second interlocking block. In certain embodiments, the method comprises connecting all of the first connecting openings of the first side of the first interlocking block to all of the second connecting openings of the second side of the second interlocking block. In further embodiments, the method comprises connecting at least one third connecting opening of a third side of the first interlocking block with at least one fourth connecting opening of a fourth side of a third interlocking block.

In some embodiments, the method comprises connecting two interlocking blocks together. In some embodiments, the method comprises connecting more than two interlocking blocks together. In additional embodiments, the method comprises connecting a plurality of blocks in different directions. In further embodiments, the method comprises connecting more than two interlocking blocks together to build a structure. In some embodiments, the structure is a wall, a floor, a foundation, or a building. In other embodiments, the structure is a floatable raft. In further embodiments, the structure is a garden.

In some embodiments, additional materials are used when connecting the interlocking blocks. In some embodiments, gaskets are placed between connected interlocking blocks. In some embodiments, fusible links and/or a sealant are placed between connected interlocking blocks to strengthen the bond between the blocks.

In some embodiments, the interlocking blocks are aligned and fused together by causing plastic coatings on each block to melt and fuse together. In other embodiments, the interlocking blocks can be aligned and glued together. In still other embodiments, the interlocking blocks can be welded or brazed together. In some embodiments, the interlocking blocks are connected together without hardware, but with another method described herein. A person of ordinary skill in the art can envision additional ways to connect the interlocking blocks of this disclosure. Such connection methods are envisioned within the scope of this disclosure.

In some embodiments, interlocking blocks are connected by the plug, sleeve, and receiving connector described herein. In such embodiments, the plug connector is inserted into one or more connecting openings or edge openings of adjacent interlocking blocks.

In some embodiments, the method further comprises connecting one or more faceplates to one or more sides of an interlocking block or to one or more side of one or more interlocked blocks. In such methods, the faceplate is aligned with a side of an interlocking block. Then, the faceplate is attached to the center opening, connecting openings, edge openings, or a combination thereof, of the side with hardware.

In further embodiments, the method comprises filling a structure comprising interlocked blocks with a fortifying material. In some embodiments, the fortifying material is insulation, foam, sand, water, gravel, rocks, cementitious material, or a combination thereof. In some embodiments, the fortifying material is poured, pumped, or otherwise added to flow through the interlocked blocks.

### Manufacturing of Interlocking Blocks

The interlocking blocks can be made through a variety of methods depending on the materials used to make the blocks. In some embodiments, the interlocking blocks are cast-poured. In other embodiments, the interlocking blocks are made from one uniform piece. In some embodiments, the interlocking blocks are made from a mold. In some embodiments, particularly where the interlocking blocks comprise plastic, the interlocking blocks are manufactured by roto-molding, rotational molding, injection molding, plastic extrusion molding, blow molding, vacuum molding, or by other suitable molding methods. In further embodiments, the interlocking blocks are constructed from two or more separately constructed components and then joined together. In some embodiments, particularly when the interlocking blocks comprise metal, the interlocking blocks are made by bolting the sides together, or welding sides together, or brazing sides together, or machining, casting, forming, joining, or assembling. In additional embodiments, particularly when the interlocking blocks comprise wood, the interlocking blocks are made by being machined, assembled, glued together, cast molded, or as an engineered wood product. In further embodiments, the interlocking blocks are produced by 3D printing or additive manufacturing, or any process in which material or materials are joined or solidified under computer control to create a three-dimensional object. In some embodiments, rapid prototyping is used to produce the interlocking blocks.

In some embodiments, the blocks are made as solid pieces and then desired center openings, connecting openings, or edge openings are drilled. For example, in some embodiments, a solid prism is manufactured and then each side is drilled with the desired configuration of openings.

### EXAMPLES

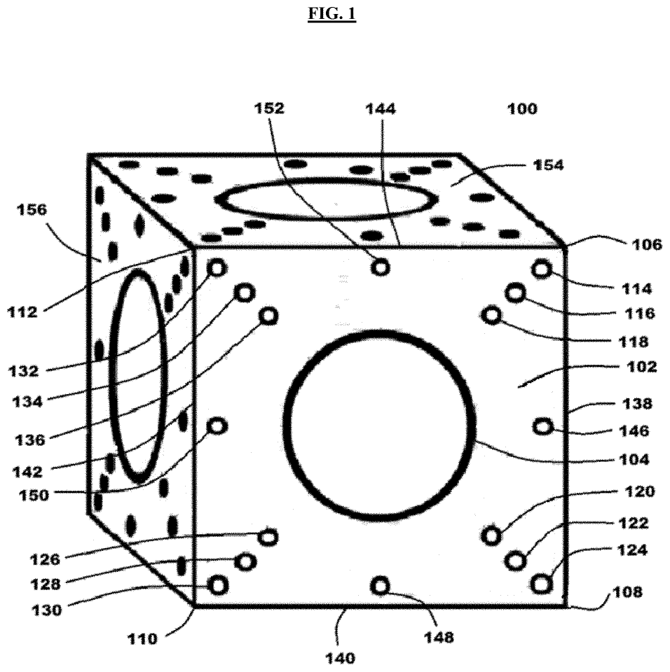

One embodiment of a rectangular interlocking block is shown in FIG. 1. Interlocking block 100 has six sides. Sides 102, 154, and 156 are shown in FIG. 1. Side 102 comprises center opening 104 around the center of side 102. Although center opening 104 is circular in FIG. 1, the center opening need not be circular. Side 102 also comprises corners 106, 108, 110, and 112. Connecting openings 114, 116, and 118 are proximate to corner 106. Connecting openings 120, 122, and 124 are proximate to corner 108. Connecting openings 126, 128, and 130 are proximate to corner 110. Connecting openings 132, 134, and 136 are proximate to corner 112.

Side 102 also comprises edges 138, 140, 142, and 144. Edge openings 146, 148, 150, and 152 are proximate to the middle of edges 138, 140, 142, and 144, respectively.

Sides 154 and 156 have the same configuration as side 102. The sides of block 100 that are not shown could also have the same configuration.

A plurality of interlocking blocks 100 can be aligned and connected together by hardware through the connecting openings and the edge openings. Interlocking blocks can be connected to all six sides of block 100. Once connected, materials, such as pipe, wires, conduit, and rebar, can also be passed through connected center openings. In some structures, faceplates can be connected to any number of sides. Once faceplates are connected, the structure can be filled with any desirable material, such as sand, foam, water, gravel, rocks, or cement.

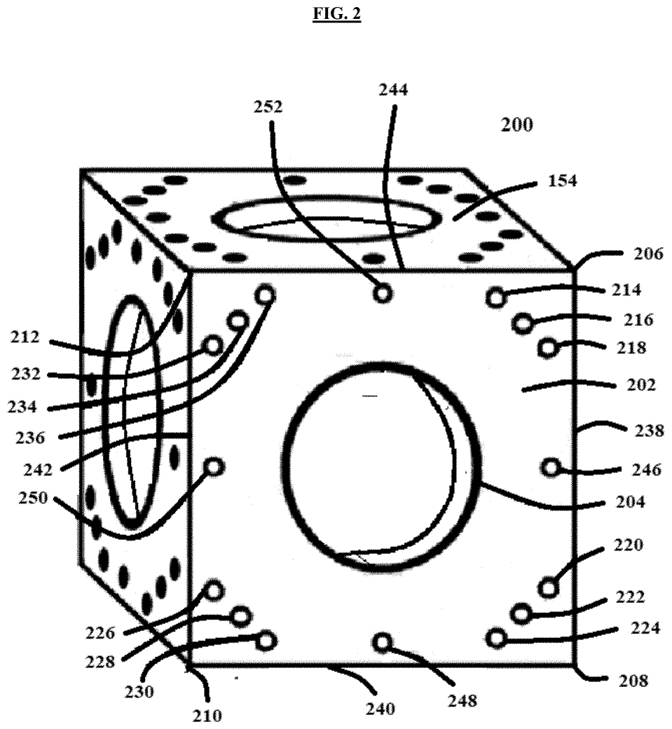

Referring now to FIG. 2, block 200 illustrates another embodiment of the interlocking blocks disclosed herein. Block 200 has connecting openings and edge openings in a different orientation than in block 100. Connecting openings 214, 216, and 218 are proximate to corner 206 on side 202 but arranged in a different orientation than the connecting openings on block 100. This is also illustrated by connecting openings 220, 222, and 224 proximate to corner 208, connecting openings 226, 228, and 230 proximate to corner 210, and connecting openings 232, 234, and 236 proximate to corner 212.

Edge openings 246, 248, 250, and 252 are proximate to the middle of edges 238, 240, 242, and 244, respectively. However, edge openings 246, 248, 250, and 252 are further from edges 238, 240, 242, and 244 and slightly closer to center opening 204 in block 200 than their counterparts in block 100. As illustrated by way of example in FIGS. 1 and 2, the configuration of openings on the interlocking blocks of this disclosure can vary. Different configurations of connecting openings, center openings, and edge openings may be desired depending on the application of the interlocking block.

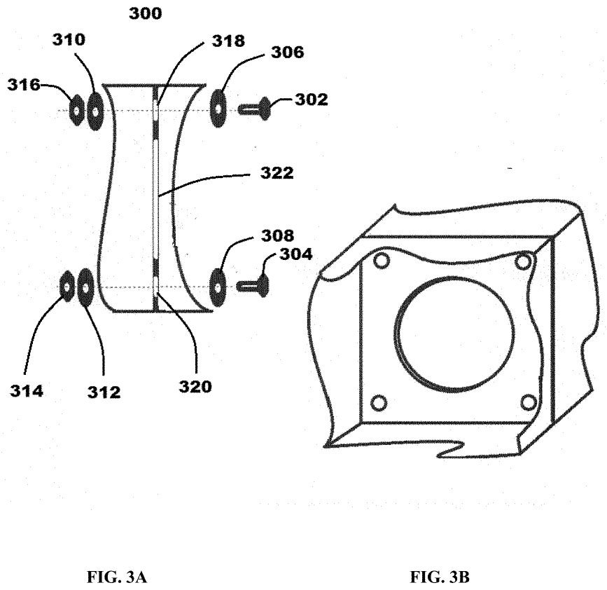

Referring now to FIG. 3A, the interlocking blocks of this disclosure can be connected together with hardware. Many different types of hardware can be used to connect the blocks. FIG. 3 shows side view of side wall 300 of two aligned interlocking blocks with hardware aligned to two aligned connecting holes. Side wall 300 comprises aligned center opening 322 and aligned connecting openings 318 and 320 of two aligned interlocking blocks. Bolt 302 goes through washer 306 then through aligned connecting opening 318. After bolt 302 goes through aligned connecting opening 318, it goes through washer 310. Then, bolt 302 can be secured through nut 316.

Similarly, bolt 304 goes through washer 308 then through aligned connecting opening 320. After bolt 304 goes through aligned connecting opening 320, it goes through washer 312. Then, bolt 304 can be secured by nut 314. Tightening nuts 314 and 316 onto bolts 304 and 302, respectively, secures the aligned interlocking blocks together.

FIG. 3B shows a cutout view of two aligned interlocking blocks without hardware.

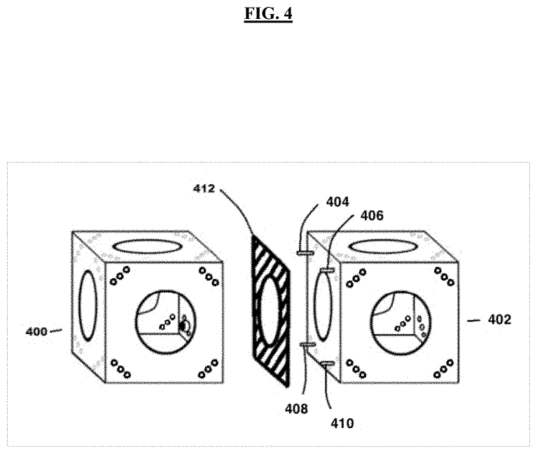

Referring now to FIG. 4, in some embodiments two or more interlocking blocks of this disclosure can be connected with a gasket between the interlocking sides. In FIG. 4, interlocking blocks 400 and 402 are aligned to be connected with hardware 404, 406, 408, and 410. Gasket 412 is placed between the sides of blocks 400 and 402. Hardware 404, 406, 408, and 410 go through holes in gasket 412 (not shown in FIG. 4) and into the corresponding connecting holes on block 400. When blocks 400 and 402 are interlocked, gasket 412 provides an additional seal between the blocks. Gasket 412 comprises any suitable gasket material, including paper, rubber, silicone, metal, cork, felt, neoprene, nitrile rubber, fiberglass, polytetrafluoroethylene (otherwise known as PTFE or Teflon), plastic, plastic comprising wires for fusing, glue, epoxy, asbestos, or combinations thereof.

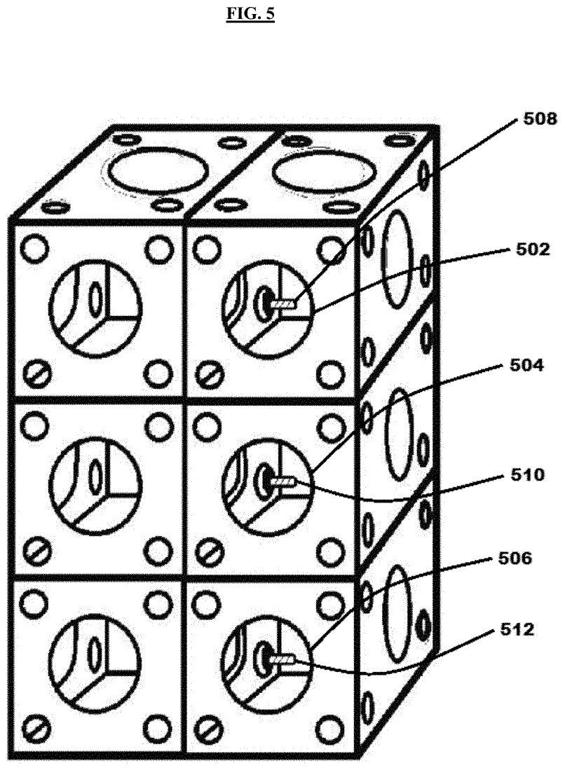

FIG. 5 shows six interlocking blocks connected together in an exemplary configuration. Hardware 508, 510, and 512 connecting the six interlocking blocks together is shown through center openings 502, 504, and 506.

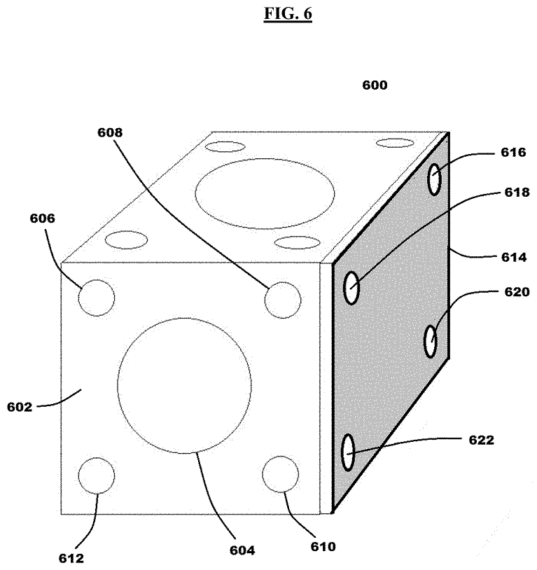

In some embodiments, one or more sides of an interlocking block can be covered with a faceplate. FIG. 6 shows an interlocking block with a faceplate covering one side of the interlocking block. Interlocking block 600 comprises six sides. Each side of interlocking block 600 has a center opening and four connecting openings. Side 602 comprises center opening 604 and connecting openings 606, 608, 610, and 612. Faceplate 614 is attached to one side of interlocking block 600. Faceplate 614 blocks the center opening of the side of interlocking block 600 to which faceplate 614 is connected (center opening obscured by faceplate 614 in FIG. 6). Faceplate 614 comprises faceplate connections 616, 618, 620, and 622 for connecting faceplate 614 to the connecting openings (not shown in FIG. 6) of the side of interlocking block 600. One or more faceplates can be connected to one or more sides of an interlocking block, depending on the application of the interlocking block.

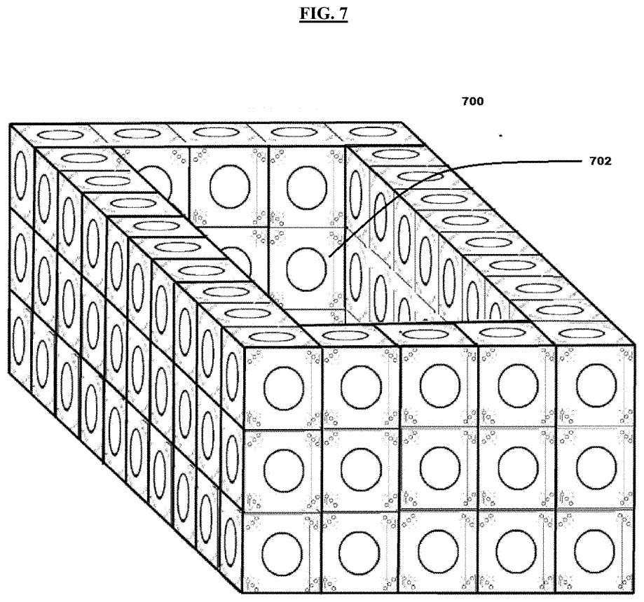

FIG. 7 shows a plurality of interlocking blocks connected together in an exemplary configuration. Structure 700 is three blocks high by five blocks wide by ten blocks long and includes cavity 702. Structure 700 can be a foundation or enclosure or a variety of other structures depending on the size of the interlocking blocks and the desired use.

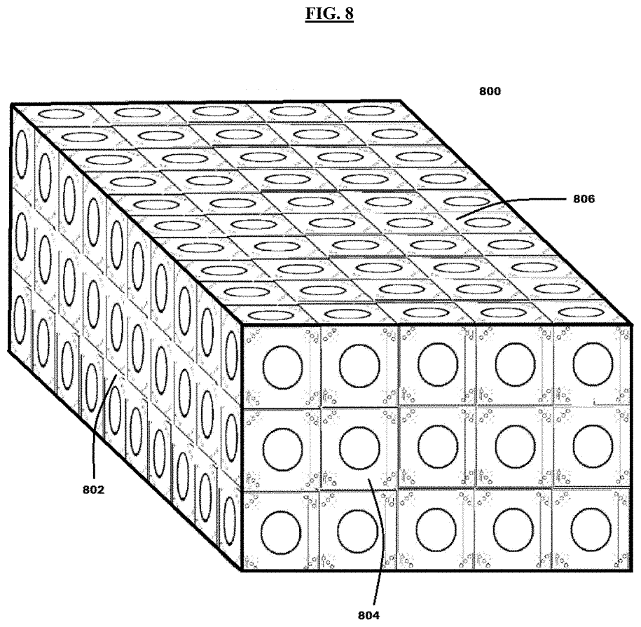

FIG. 8 shows a plurality of interlocking blocks connected together in another exemplary configuration. Structure 800 does not comprise a cavity and is a solid prism comprised of interlocked blocks. Like structure 700, structure 800 is three blocks high by five blocks wide by ten blocks long. Structure 800 can also be a foundation, although, unlike structure 700, likely could not be used as an enclosure given the lack of cavity. Depending on the size of interlocking blocks in structure 800, structure 800 could be used as a wall. Faceplates can be attached to the interlocking blocks of sides 802 and 804. Then, fortifying material can be poured through the center openings of the interlocking blocks of side 806.

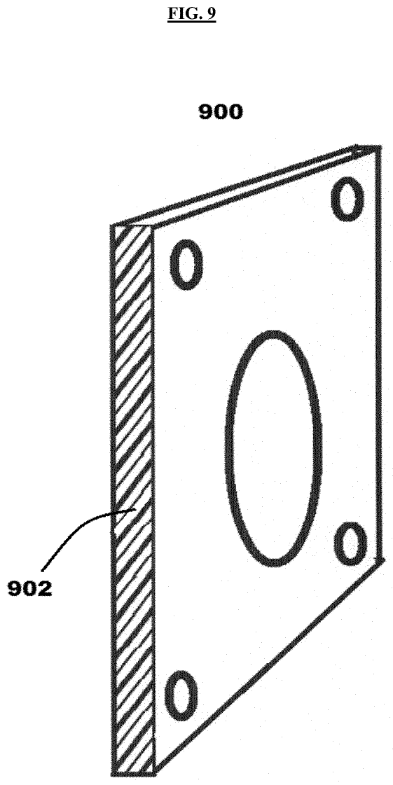

FIG. 9 shows as perspective of side removed from an interlocking block (not shown). Sidewall 902 can have a variety of thickness depending on the size, material, and use of the interlocking block. Sidewall 902 is solid. However, the walls of interlocking blocks can be hollow, can comprise two or more walls, or be filled with a material, such as insulation, gas, liquid, foam, cement, rocks, gravel, or a combination thereof.

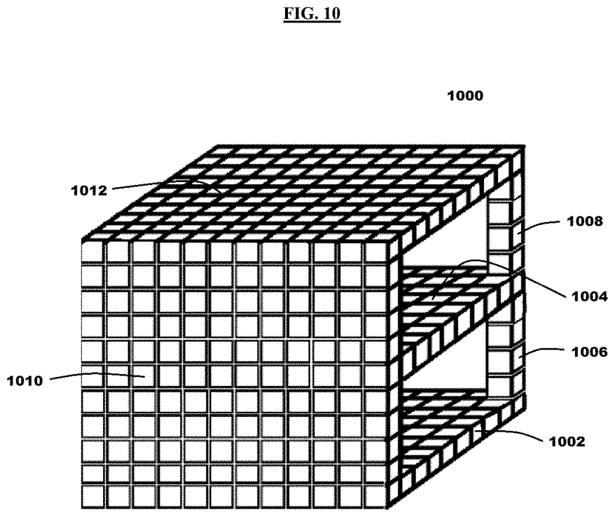

Referring now to FIG. 10, structure 1000 represents a building structure comprised of interlocking blocks. Structure 1000 comprises floors 1002 and 1004 and posts 1006 and 1008. Structure 1000 also comprises wall 1010 and top level 1012. Depending on the size of the interlocking blocks, structure 1000 can be a large building, such as for human habitation, or a smaller building, such as a utility shed. Structure 1000 illustrates just one of many different possible structures.

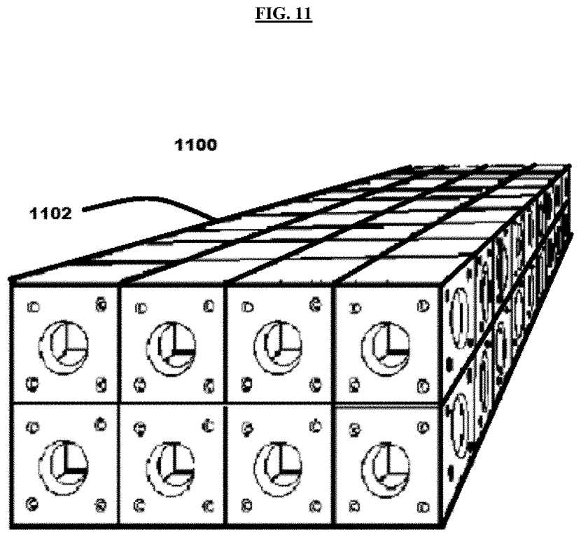

FIG. 11 shows structure 1100 comprising 72 interlocking blocks connected mechanically. Faceplates are connected to each interlocking block of top side 1102.

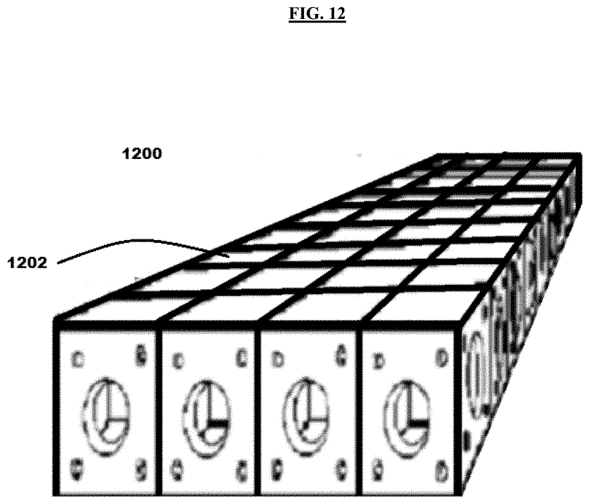

FIG. 12 shows structure 1200 comprising 36 interlocking blocks connected mechanically. Faceplates are connected to each interlocking block of top side 1202.

FIG. 13 shows an embodiment of a plug, sleeve, and receiving connector. Plug 1302 can go into sleeve 1304 and be threaded into receiving connector 1306. In FIG. 13, plug 1302 has threads on the outside to thread into sleeve 1304 and threads on the inside so receiving connector 1306 can thread into plug 1302.

FIG. 14 shows an embodiment of an assembled plug, sleeve, and receiving connector. Plug 1402 is threaded into sleeve 1404. Receiving connector 1406 is threaded into plug 1402 inside of sleeve 1404.

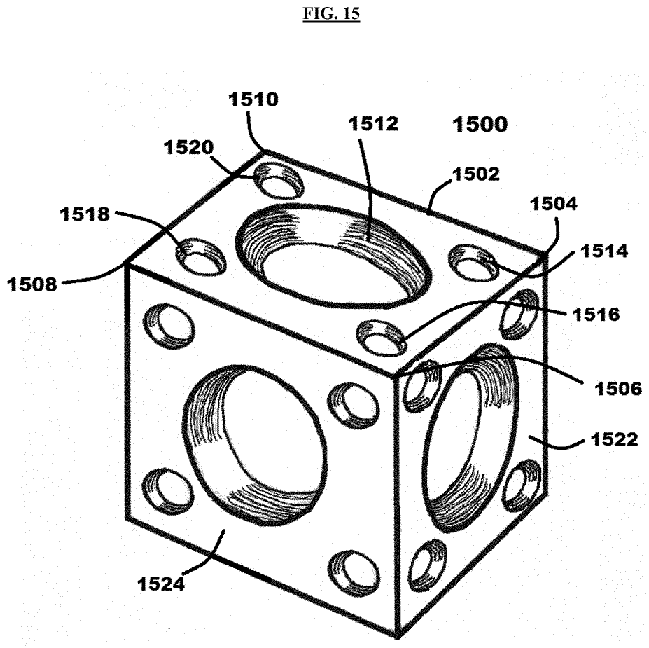

FIG. 15 shows another embodiment of an interlocking block. Block 1500 is a rectangular prism having six sides. Top side 1502 comprises corners 1504, 1506, 1508, and 1510. Top side 1502 also comprises center opening 1512 and connecting openings 1514, 1516, 1518, and 1520 proximate to corners 1504, 1506, 1508, and 1510. Sides 1522 and 1524 have the same configuration of center opening, corners, and connecting openings proximate to the corners.

### Retaining Wall and Seawall

In some embodiments, the interlocking prisms of this disclosure are designed to form a seawall or retaining wall. In such embodiments, a plurality of interlocking prisms are interlocked together to form the desired wall of any desired configuration. In certain embodiments, the wall can be made vertical. In other embodiments, the wall is a gravity wall, piling wall, cantilever wall, or an anchored wall. In other embodiments, the interlocking blocks are arranged to create walls with angles or corners or curved. In still other embodiments, a wall comprising interlocked blocks is built at an incline. In some embodiments, the tops and bottoms of the interlocked blocks comprise protrusions and corresponding indentations to receive the protrusions to allow the blocks to connect at an offset to create an incline. In other embodiments, the shape of the interlocking blocks enables an incline to be created.

Then, faceplates are attached to the openings of each block on either side of the wall. The faceplates are secured in place so that the interiors of the blocks can be filled with a desired material. In some embodiments, the interior of the interlocking block wall is filled with sand. In some embodiments, the interior of the interlocking block wall is filled with cement. In other embodiments, the interior of the interlocking block wall is filled with rocks or gravel. In further embodiments, the interior of the interlocking block wall is filled with a material of sufficient mass or strength to retain whatever the retaining wall is designed to retain.

Sea walls made from the interlocking blocks have several advantages over seawalls comprised of sand bags. For one, sea walls made from interlocking blocks prevent, or at least better inhibit, liquid seepage. Two, sea walls made from interlocking blocks are stronger than sand bags due to the blocks being mechanically connected. Three, the sea wall made of interlocking blocks can be filled with a fortifying material such as cement or sand, thereby increasing the strength of the sea wall. Furthermore, in some embodiments, the interlocking blocks are made of a cloth material. Such interlocking blocks can be interlocked and filled with sand to provide a superior sand bag-like structure with mechanically connected blocks.

Interlocking blocks intended to be used to create a sea wall can be made of non-corroding materials in order to withstand the corrosive nature of the sea.

### Foundation and Structures

In other embodiments, the interlocking blocks of this disclosure are designed to form a foundation for a building or other structure. In such embodiments, a plurality of interlocking blocks are connected in horizontal and vertical fashion according to a design for a foundation. The foundation can have any suitable shape depending on the structure being built. In some embodiments, the connected interlocking blocks form the foundation without material poured into the structure. In other embodiments, once the requisite number of interlocking blocks are connected, faceplates can be added to the interior face and exterior face of the wall created by the interlocked blocks. Then, a fortifying material can be poured into the interlocked block structure, thereby creating a foundation. Additional structures can be built on top of the foundation.

In other embodiments, the interlocking blocks of this disclosure are designed to build a structure. The structure could be a residential building, a commercial building, an office building, sports arena, or any building. In some embodiments, the building is a small building such as a garage or shed. In other embodiments, the building is a residential building such as a house. In further embodiments, the building is a large building. The size of the interlocked blocks used in buildings can vary depending on the size of the building being constructed.

### Flotation

In another embodiment, the interlocking prisms of this disclosure are comprised of a buoyant material. In such embodiments, a plurality of interlocking prisms can be interlocked together to create a flotation device. In such embodiments, a plurality of blocks are interlocked together. Then, in some embodiments, faceplates are attached to the sides of the flotation device that will face the water, thereby preventing water from coming into the flotation device. In some embodiments the sides of the interlocking block comprise an interior wall and an exterior wall and the space between the interior wall and exterior wall is hollow or filled with a liquid, foam, or gas, or some material to help make the interlocking block buoyant.

The flotation devices comprised of interlocking blocks can vary in size. In some embodiments, the flotation device is a raft designed to hold one or more people. In other embodiments, the flotation device is a barge designed to float cargo. In other embodiments, the flotation device has one or more walls and/or one or more rooms.

### Toys

In particular embodiments, the interlocking blocks are designed as toys. In such embodiments, the interlocking blocks comprise material that toys are typically made of, such as plastic. In such embodiments, the interlocking blocks have a size suitable to be a toy, e.g., ranging from about 1 inch to about 24 or about 12 inches. In some embodiments, the blocks are clear. In other embodiments, the blocks have color. In further embodiments, the blocks are a combination of clear and color.

In certain embodiments where the interlocking blocks are toys, this disclosure provides kits comprising a plurality of interlocking blocks. Users of the kits can create numerous structures from the interlocking blocks. In some embodiments, the kits comprise interlocking blocks designed to make a particular structure.

In embodiments where the interlocking blocks are toys, the hardware used to connect the interlocking blocks can be designed to be easy to use for children. Furthermore, the hardware for toy interlocking blocks can be designed to be easily interlocked and disconnected so that children can easily assemble and disassemble blocks and structures.

### Garden

In further embodiments, the interlocking blocks are designed to be used in a garden. In such embodiments, a plurality of interlocking blocks can be connected together in a desired arrangement. Each block can be filled with dirt, seeds, and other gardening materials. The interlocking blocks create a specific area for a person to grow plants. Faceplates can be attached to sides of the interlocked blocks of the garden structure to help retain dirt and water in the garden structure.

This disclosure provides kits comprising a plurality of interlocking blocks for gardening. In such kits, the interlocking blocks comprise a material suitable for gardening, i.e., lightweight and weather-resistant. In some embodiments, such kits comprise a number of interlocking blocks, hardware for connecting the number of blocks, a number of faceplates for connecting to a number of sides of the interlocking blocks, and hardware for the faceplates. In some embodiments, the kits further comprise instructions for connecting the blocks and/or suggested configurations for the blocks.

### EQUIVALENTS

Those skilled in the art will recognize, or be able to ascertain, using no more than routine experimentation, numerous equivalents to the specific embodiments described specifically in this disclosure. Such equivalents are intended to be encompassed in the scope of this disclosure and the following claims.

1. A kit for building a sea wall configured to be filled with gravel, sand, cementitious material, or a combination thereof, comprising:
a first cementitious interlocking block comprising:
an interior; and
six sides comprising:
a first interlocking side comprising:
a first side center opening around the center of the first interlocking side,
four first side corners,
four first side interlocking openings, each first side interlocking opening being proximate to a first side corner,
a second cementitious interlocking block comprising:
an interior; and
six sides comprising:
a second interlocking side comprising:
a second side center opening around the center of the second interlocking side,
four second side corners,
four second side interlocking openings, each second side interlocking opening being proximate to a second side corner;
hardware for mechanically interlocking the first interlocking side and the second interlocking side via the first side interlocking openings and the second side interlocking openings; and
one or more faceplates configured to fit on a side of the first cementitious interlocking block or on a side of the second cementitious interlocking block and cover the side; and
wherein the sides of the first cementitious interlocking block and the sides of the second cementitious interlocking block are of a thickness sufficient for the cementitious wall to contain gravel, sand, cementitious material, or a combination thereof.

2. The kit of claim 1, wherein the first cementitious interlocking block and the second cementitious interlocking block are configured for attachment to additional cementitious interlocking blocks.

3. A seawall configured to be filled with gravel, sand, cementitious material, or a combination thereof, comprising:
a first interlocking block comprising:
a first block interior;
cementitious material, plastic, or a combination thereof; and
six first block sides comprising:
a first block interlocking side comprising:
a first block side center opening around the center of the first interlocking side,
four first block side corners,
four first block side interlocking openings, each first block side interlocking opening being proximate to a first block side corner,
a second interlocking block comprising:
a second block interior;
cementitious material, plastic, or a combination thereof; and
six second block sides comprising:
a second block interlocking side comprising:
a second block side center opening around the center of the second block interlocking side,
four second block side corners,
four second block side interlocking openings, each second block side interlocking opening being proximate to a second block side corner;
wherein the first block interlocking side and the second block interlocking side are mechanically interlocked by hardware through the first block side interlocking openings and the second block side interlocking openings;
wherein the cementitious wall comprises at least one faceplate configured to cover an opening; and
wherein the first block sides and the second block sides are of a thickness sufficient for the cementitious wall to contain gravel, sand, cementitious material, or a combination thereof.

4. The seawall of claim 4, further comprising gravel, sand, cementitious material, or a combination thereof in the first block interior and the second block interior.

5. The seawall of claim 1, further configured for attachment to additional interlocking blocks.

6. A method of building a seawall, comprising
providing a plurality of interlocking blocks, each interlocking comprising:
a hollow interior;
six sides, each side comprising:
a side center opening around the center of the side,
four side corners,
four side interlocking openings, each side interlocking opening being proximate to a side corner,
mechanically interlocking two or more of the plurality of interlocking blocks comprising:
aligning the side interlocking openings of two or more of the plurality of interlocking blocks; and
mechanically connecting the side interlocking openings via hardware, thereby interlocking the two or more of the plurality of interlocking blocks;
attaching a plurality of faceplates to a plurality of sides of the two or more interlocked blocks; and
adding sand, gravel, or cementitious material to the interiors of the interlocked blocks.

7. The method of claim 6, further comprising mechanically connecting additional interlocking blocks to the interlocked blocks.

8. The method of claim 7, further comprising adding additional faceplates to the additional interlocking blocks and adding sand, gravel, or cementitious material to the interiors of the additional interlocked blocks.
